(19) United States
(12) Patent Application Publication
(10) Pub. No.: US 2018/0230061 A1
(43) Pub. Date: Aug. 16, 2018

(54) BINDER FORMULATIONS AND USES THEREOF FOR FORMING AGGLOMERATED PRODUCTS OF PARTICULATE MATERIAL

(71) Applicant: Cytec Industries Inc., Princeton, NJ (US)

(72) Inventors: Howard HASELHUHN, Troy, MI (US); Devarayasamudram Ramachandran NAGARAJ, Ridgefield, CT (US); Ravi R. HIREMATH, Stamford, CT (US); Xin LI, Stamford, CT (US)

(21) Appl. No.: 15/892,837

(22) Filed: Feb. 9, 2018

Related U.S. Application Data
(60) Provisional application No. 62/457,324, filed on Feb. 10, 2017.

(51) Int. Cl. C04B 35/634; C04B 35/26; C04B 35/63

(52) U.S. Cl. CPC C04B 35/63444; C04B 35/26; C04B 35/6316; C04B 2235/60; C04B 2235/48; C04B 2235/349; C04B 35/63428

(57) ABSTRACT

Agglomerated products formed from particulate materials and binder formulations having low molecular weight polymers (of 500 g/mol to 50,000 g/mol) in an aqueous or emulsion form, or having a blend of low molecular weight aqueous polymer and high molecular weight (of 500,000 g/mol to 50,000,000 g/mol) emulsion polymers, wherein the polymers are formed from water soluble ethylenically unsaturated monomers, or monomer blends, chosen from one or more of acrylic acid, acrylamide, maleic acid, allyl sulfonate, silanated and/or hydroxamated acrylamide, or 2-acrylamido-2-methylpropane sulfonic acid (AMPS), are disclosed herein as well as processes for agglomerating a particulate materials, and use of the binding agents for forming same.

### CROSS-REFERENCE TO RELATED APPLICATIONS

This application claims benefit of priority to co-pending U.S. Provisional Application No. 62/457,324 filed Feb. 10, 2017, which is incorporated herein by reference in its entirety.

### BACKGROUND OF THE INVENTION

### 1. Field of the Invention

The field of the invention generally relates to processes for agglomerating particulate materials using a binding agent, and to the agglomerated products incorporating the binding agent produced from such processes. The field of the invention also relates to certain formulations of binding agents and their application for use in agglomerating particulate materials.

### 2. Description of the Related Art

Agglomeration is commercially used in industries where materials are encountered in a form which is too finely divided (such as powder, dust, chip, or the like) for convenient processing or handling. In such instances, there is generally a desire to upgrade the size, density, and/or uniformity of these finely divided particles for more efficient handling, processing, or recovery. Agglomeration is particularly useful in the metal refining industries, where the concentrate ore is finely divided.

The prior art is replete with a summary of technology for agglomerating finely divided particles as related to the metal refining industries, and particularly for metallic ores such as iron ore, as well as for processes and binder formulations that seek to improve it. An overall view of the agglomeration of iron ore is given, for example, by Eisele and Kawatra, A review of binders in iron ore pelletization, Mineral Processing and Extractive Metallurgy Review, vol. 24, No. 1 (2003); and by Halt and Kawatra, Review of organic binders for iron ore concentrate agglomeration, Minerals and Metallurgical Processing Journal, vol. 31, No. 2 (2014).

Additionally, the patent literature provides numerous references treating subject matter related to the invention. For example, any of U.S. Pat. No. 4,684,549 to Allen et al.; U.S. Pat. No. 5,698,007 to Schmitt; U.S. Pat. No. 6,152,985 to Allen; and U.S. Pat. No. 6,384,126 to Pirtle et al.; or U.S. Patent Application Publication Nos. 2014/0033872 to Martikainen et al.; and 2014/0190310 to Tooge et al.; or Int'l Publication No. WO 91/16463, provide a general overview of the technology for agglomerating iron ore and the current state of the field.

As the quality of mined iron ore has decreased globally, due to concentrates derived from low-grade ores and fines, alternatives to using bentonite as the predominant binding agent have increased. Although bentonite as a binding agent produces green balls with good wet and dry strengths, and also a desired degree of moisture control, its use also has several disadvantages including high levels of silica (often over 50% SiO₂) because optimum grades of bentonite are less available or too costly to use in the quantity required as a binder for iron ore pelletization.

Since bentonite must be present in the pellets in relatively large amounts, the higher levels of silica are not desirable because it decreases the quantity of iron in the pellets, increases acidic gangue to form scabs on the furnace wall (thereby decreasing the efficiency of the blast furnace operations used in smelting the ore by increasing fuel consumption), and reduces the pore volume and surface/mass ratio of the formed pellets (thereby decreasing the reduction of the iron oxide to steel). Additionally, the spalling temperature of bentonite (defined by determining the minimum temperature at which “spalling” (i.e., bursting or degradation of the agglomerated product upon exposure to firing temperatures) occurs, or by observing the percentage of fines formed during a particular firing cycle), and many known binding agents is undesirably low.

Accordingly, an alternative to bentonite that can fully or even partially replace it as a binding agent for agglomeration of particulate materials such as iron ore and reduce the silica content thereby increasing the quantity of iron in the pellets, increasing the porosity of the formed pellets for enhanced reducibility, and increasing the efficiency and productivity of the smelting operation, but without diminishing the performance properties of bentonite in terms of increased moisture absorption, and good dry strength and wet drop number that are required to create a suitable green ball, would be a useful advance in the art and could find ready acceptance by the industry.

### SUMMARY OF THE INVENTION

The foregoing and additional objects are attained in accordance with the principles of the invention wherein the inventors describe herewith for the first time the use of a particular binder formulation suitable as a bentonite replacement, wherein the binder formulation is advantageously capable of supplementing bentonite to increase moisture absorption of an agglomerated particulate material/product, while concurrently providing the desired mechanical performance characteristics achieved by using bentonite alone.

The binding agent formulations and the agglomerated products incorporating them advantageously reduce silica content, increase the porosity of the formed product, and can be used alone or with other binder additives to tailor the performance requirements that may be required for different particulate materials.

Accordingly, in one aspect the invention provides an agglomerated product having

i) a particulate material; and

ii) a binding agent comprising a polymer having a weight average molecular weight of 500 g/mol to 50,000 g/mol formed from water soluble ethylenically unsaturated monomers, or monomer blends, selected from the group consisting of:

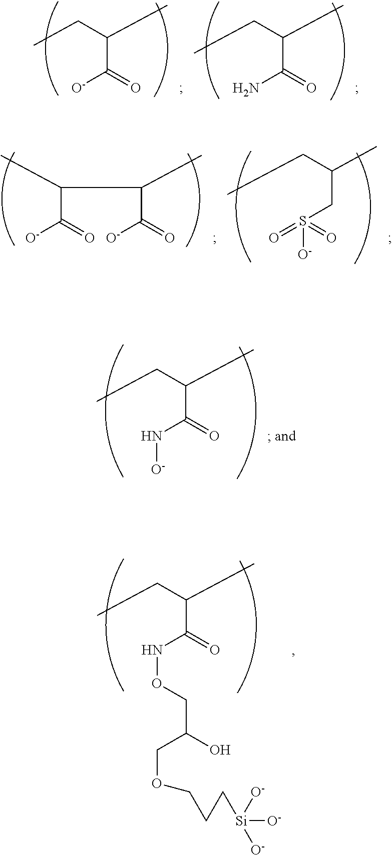

wherein each of the oxygen anions is independently hydrolyzed (—OH), methylated (—OCH3), or is a sodium (—ONa) or potassium (—OK) salt.

In another aspect, the invention provides a process for agglomerating a particulate material by performing (in an unlimited manner) the steps of:

a) forming an intimate mixture of the particulate material and an effective amount of a binding agent as fully described and/or defined herewith by the instant application in the presence of moisture to obtain an agglomerate feed; and

b) shaping the feed into a plurality of wet agglomerated products by any suitable means, thereby agglomerating a particulate material and producing an agglomerated product.

This summary of the invention may not list all necessary characteristics and, therefore, subcombinations of these characteristics or elements may also constitute an invention. These and other objects, features and advantages of this invention will become apparent from the following detailed description of the various aspects of the invention taken in conjunction with the accompanying Examples.

### DETAILED DESCRIPTION OF CERTAIN EMBODIMENTS OF THE INVENTION

The present invention will now be described more fully hereinafter. The invention may be embodied in many different forms and should not be construed as limited to the embodiments set forth herein; rather, these embodiments are provided so that this disclosure will satisfy applicable legal requirements. Unless otherwise defined, all terms of art, notations and other scientific or industrial terms or terminology used herein are intended to have the meanings commonly understood by those of skill in the chemical and/or minerals and metallurgical processing arts. In some cases, terms with commonly understood meanings are defined herein for clarity and/or for ready reference, and the inclusion of such definitions herein should not necessarily be construed to represent a substantial difference over the definition of the term as generally understood in the art unless otherwise indicated. As used herein and in the appended claims, the singular forms include plural referents unless the context clearly dictates otherwise. Throughout this specification, the terms retain their definitions.

Those skilled in the art will appreciate that while preferred embodiments are discussed in more detail below, multiple embodiments of the reagent system and processes described herein are contemplated as being within the scope of the present invention. Thus, it should be noted that any feature described with respect to one aspect or one embodiment of the invention is interchangeable with another aspect or embodiment of the invention unless otherwise stated.

Furthermore, for purposes of describing the present invention, where an element, component, or feature is said to be included in and/or selected from a list of recited elements, components, or features, those skilled in the art will appreciate that in the related embodiments of the invention described herein, the element, component, or feature can also be any one of the individual recited elements, components, or features, or can also be selected from a group including any two or more of the explicitly listed elements, components, or features. Additionally, any element, component, or feature recited in such a list may also be omitted from such list.

Those skilled in the art will further understand that any recitation herein of a numerical range by endpoints includes all numbers subsumed within the recited range (including fractions), whether explicitly recited or not, as well as the endpoints of the range and equivalents. Disclosure of a narrower range or more specific group in addition to a broader range or larger group is not a disclaimer of the broader range or larger group.

The terms “comprised of,” “comprising,” or “comprises” as used herein includes embodiments “consisting essentially of” or “consisting of” the listed elements.

Accordingly, in one aspect, the present invention relates to formulations of binding agents and their application for use in agglomerating particulate materials to form an agglomerated product. The term “agglomerated” or “agglomeration” as used in the context of the present invention refers to the processing of finely divided materials, whether in powder, dust, chip, flake, or other particulate form, to form pellets, granules, balls, briquettes, or the like.

In certain embodiments, the binding agent can include a polymer having a weight average molecular weight of 500 g/mol to 50,000 g/mol formed from water soluble ethylenically unsaturated monomers, or monomer blends, selected from the group consisting of:

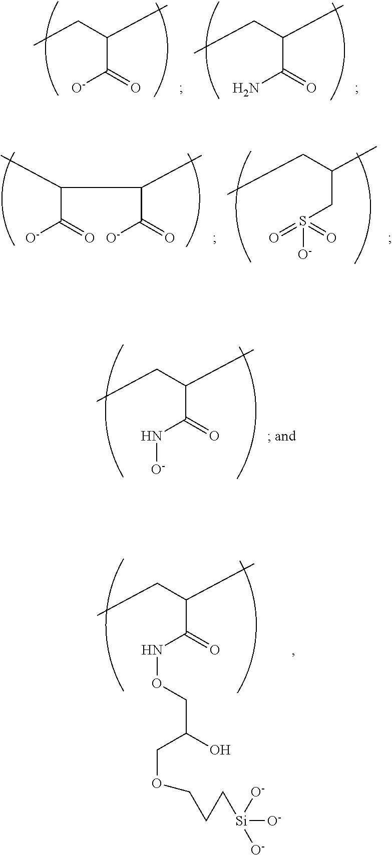

wherein each of the oxygen anions is independently hydrolyzed (—OH), methylated (—OCH3), or is a sodium (—ONa) or potassium (—OK) salt.

As used herein, the terms “polymer,” “polymers,” “polymeric,” and similar terms are used in their ordinary sense as understood by one skilled in the art, and thus may be used herein to refer to or describe a molecule (or group of such molecules) that contains recurring units. Polymers may be formed in various ways, including by polymerizing monomers and/or by chemically modifying one or more recurring units of a precursor polymer. A polymer may be a “homopolymer” comprising substantially identical recurring units formed by, e.g., polymerizing a particular monomer. A polymer may also be a “copolymer” comprising two or more different recurring units formed by, e.g., copolymerizing two or more different monomers, and/or by chemically modifying one or more recurring units of a precursor polymer. The term “terpolymer” may be used herein to refer to polymers containing three or more different recurring units.

As those skilled in the art will recognize, the polymers comprising the binding agents disclosed herein are commonly known in the art and, thus, can either readily be made or possibly obtained commercially. Those skilled in the art will further recognize that the polymers described herein as useful for agglomerating particulate materials can contain various polymer chains of unequal length, and will therefore contain a distribution of molecular weights. Molecular weight of the polymers described herein can be determined by any routine methods available in the art including, for example, by gel permeation chromatography (GPC), or size exclusion chromatography (SEC).

In some embodiments, the binding agent includes a polymer having from 0 mol % to 100 mol % of acrylic acid and/or from 100 mol % to 0 mol % of acrylamide, provided that the amount of acrylic acid and acrylamide in a polymer cannot both be 0 mol % or 100 mol %, and wherein said polymer has a weight average molecular weight of 2,000 g/mol to 15,000 g/mol (i.e., a polymer of low molecular weight). In certain embodiments, the binding agent can include a copolymer having from 30-50 mol % of acrylic acid and 70-50 mol % of acrylamide, and has a weight average molecular weight of 2,000 g/mol to 12,000 g/mol. In the same or other embodiments, the binding agent can include from 90 mol % to 100 mol % of acrylic acid of low molecular weight.

In certain embodiments, the binding agent can include a polymer having from 0 mol % to 100 mol % of sodium allyl sulfonate and/or from 100 mol % to 0 mol % of maleic acid, provided that the amount of sodium allyl sulfonate and maleic acid in a polymer cannot both be 0 mol % or 100 mol %, and wherein said polymer has a weight average molecular weight of 500 g/mol to 5,000 g/mol. In the same or other embodiments, the binding agent can include a copolymer of 30-50 g/mol of sodium allyl sulfonate and 70-50 g/mol of maleic acid, and has a weight average molecular weight of 1,000 to 3,000 g/mol.

In any or all embodiments, the binding agent can include a low molecular weight polymer that is hydroxamated and/or silanated. Hydroxamation or silanation of such polymer can be conducted by any methods known to those skilled in the art, including at least those described in U.S. Pat. No. 6,608,137 or U.S. Patent Application Publication No. 2016/0159660. In one preferred embodiment, the hydroxamated and/or silanated polymer of the binding agent has a weight average molecular weight of 5,000 g/mol to 10,000 g/mol.

The low molecular weight polymers that make up the binding agent can be made according to any methods known to those skilled in the art, and can be in an aqueous or emulsion form. In those embodiments where the low molecular weight polymer is hydroxamated and/or silanated, the polymer is preferably in emulsion form.

In any or all embodiments described herein, the binding agent can further include a second polymer in the form of an emulsion having a weight average molecular weight of at least 500,000 g/mol (i.e., a polymer of high molecular weight), formed from water soluble ethylenically unsaturated monomers, or monomer blends, selected from the group consisting of:

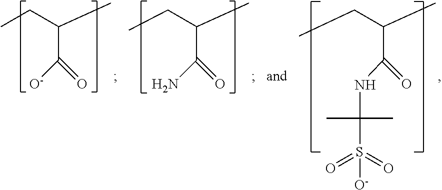

wherein each of the oxygen anions is independently hydrolyzed (—OH), methylated (—OCH3), or is a sodium (—ONa) or potassium (—OK) salt. In the same or other embodiments, it is contemplated that the second polymer (alternatively referred to herein as a high molecular weight polymer) can have a weight average molecular weight from 1,000,000 g/mol to 50,000,000 g/mol. In certain preferred embodiments, the high molecular weight polymer can have a weight average molecular weight from 1,000,000 g/mol to 25,000,000 g/mol; more preferably still from 1,000,000 g/mol to 10,000,000 g/mol. In any or all embodiments of the binding agent that include a high molecular weight polymer, the polymer can also be hydroxamated and/or silanated.

In certain preferred embodiments the second polymer can have a weight average molecular weight of at least 1,000,000 g/mol and can include from 0 mol % to 100 mol % of acrylic acid and/or from 100 mol % to 0 mol % of acrylamide, provided that the amount of acrylic acid and acrylamide in a second polymer cannot both be 0 mol % or 100 mol %. In the same or other embodiments, the high molecular weight polymer can include a copolymer having from 30-50 mol % of acrylic acid and 70-50 mol % of acrylamide, based on 100 mol %. In a preferred embodiment, the high molecular weight polymer can include a copolymer of 50 mol % of acrylic acid and 50 mol % of acrylamide.

In other embodiments, the second polymer can further include from 5 mol % to 20 mol % of 2-acrylamido-2-methyl-1-propane sulfonic acid.

In any or all embodiments of the binding agent that includes a high molecular weight polymer, the high molecular weight polymer can be present in an amount from 30 mol % to 80 mol % in relation to the total polymer content of the binding agent.

In a specific embodiment, the binding agent can include a first polymer (i.e., a low molecular weight polymer) in the form of an aqueous or emulsion copolymer having 30 mol % acrylic acid and 70 mol % acrylamide and a weight average molecular weight from 500 g/mol to 50,000 g/mol (preferably from 2,000 g/mol to 12,000 g/mol), and a second polymer (i.e., a high molecular weight polymer) in the form of an emulsion copolymer having 50 mol % of acrylic acid and 50 mol % of acrylamide and a weight average molecular weight of 500,000 g/mol to 50,000,000 g/mol (preferably at least 1,000,000 g/mol).

In any or all of the embodiments of the invention, the binding agent can further include an agglomerating additive to enhance mechanical and/or physical properties of the agglomerated product (e.g., drop number, wherein a high drop number for “green” agglomerated products is desirable). In such embodiments where the agglomerating additive is present, it can be chosen from any of polysaccharides (e.g., hydroxyethyl cellulose, hydroxypropyl cellulose, carboxy methyl cellulose, carboxymethylhydroxyethyl cellulose, methyl cellulose, hydroxypropyl methyl cellulose, guar, hydroxypropyl guar, sugar beet pulp, starch, and the like); urea; sodium acetate; sodium citrate; sodium chloride; sodium oxalate; sodium tartrate; sodium benzoate;

sodium stearate; sodium bicarbonate; sodium carbonate; sodium silicate; and the corresponding ammonium, potassium, calcium, or magnesium salts of the preceding salts; calcium oxide; calcium hydroxide; calcium carbonate; magnesium oxide; magnesium hydroxide; clay minerals; wollastonite; and mixtures thereof.

In certain embodiments, the agglomerating additive can be a clay mineral such as a phyllosilicate mineral chosen from serpentine minerals, kaolinite, talc, pyrophyllite, mica, illite, vermiculite, bentonite, and mixtures of any of these minerals.

The effective amount of binding agent required to agglomerate the fine particles will vary depending upon numerous factors such as, but not limited to, the type of particulate material to be agglomerated, the moisture content of the particulate material, particle size, agglomeration equipment, and desired properties of the final product, e.g., dry strength (crush), drop number, size, and finish (i.e., smoothness). “Effective amount” of binding agent as referred to herein means the amount necessary to suitably bind the particulate material to provide the desired performance features in the agglomerated product. In any or all embodiments, the effective amount of binding agent can be present in an amount from 0.001 wt. % to 5 wt. % of the total weight of the agglomerated product. In a preferred embodiment, the binding agent can be present in an amount from 0.001 wt. % to 1.5 wt. % of the total weight of the agglomerated product. In the same or other embodiments, the amount of agglomerating additive in such binding agent will vary depending on the user's objective, but will generally be less than 5 wt. %; less than 3 wt. %; less than 2.5 wt. %; less than 1.5 wt. %; less than 1 wt. %; less than 0.10 wt. %; or less than 0.05 wt. %, based on the total weight of the agglomerated product.

The particulate material that can be agglomerated in the accordance with the present invention can be any finely divided material including, but not limited to, minerals, fertilizers, and wood pulp. In preferred embodiments, the particulate material of the agglomerated product is present in at least 95 wt. % of the total weight of the agglomerated product. In certain embodiments, the particulate material can be present up to 99.999 wt. % based on the total weight of the agglomerated product.

In certain embodiments, the particulate material can be a mineral in the form of a concentrate, a tailing, fines, and/or ore. In the same or other embodiments, the particulate material can be a metallic mineral including, but not limited to, iron-bearing ores (e.g., taconite, magnetite, hematite; limonite; goethite; siderite); itabirite; franklinite; pyrite; chalcopyrite; chromite; ilmenite; chrome ore; gold ore; silver ore; copper ore; nickel ore; zinc ore; lead ore; uranium ore; barium ore; niobium; casiterite; rutile; and mixtures of any of these. In a preferred embodiment, the metallic mineral is an iron-bearing ore.

In certain other embodiments, the particulate material can be a non-metallic mineral including, but not limited to, phosphate rock; talc; dolomite; limestone; potassium sulfate; ammonium phosphate; potassium chloride; double sulfate of potassium and magnesium; magnesium oxide; calcium phosphate; carbon black; coal; calcite, quartz; and mixtures of any of these.

In still other embodiments, the particulate can be wood pulp. As used herein, “wood pulp” refers to finely ground, micronized lignocellulose or plant biomass that is composed of cellulose, hemicellulose, and lignin. The type or source of wood fiber may be any type or source known to those skilled in the art as useful in the agglomerated products described herein, or which is described in detail in published application number US2014/0033872.

In another aspect, the present invention provides processes for agglomerating particulate material by forming an intimate mixture of the particulate material and an effective amount of a binding agent (in accordance with the context of the present invention as fully described herein), in the presence of moisture to obtain an agglomerate feed, and shaping the feed into a plurality of wet agglomerated products by any suitable means, thereby agglomerating the particulate material.

Any known method for forming agglomerated products can be used to prepare the agglomerated products according to the invention. A non-limiting example can include rotating the particulate material in a drum or disc with a binding agent and water. Agglomerates can also be formed by briquetting, nodulizing, or spray drying according to suitable methods known to those skilled in the art. In any or all embodiments, water (i.e., distilled, tap, deionized, or process stream water) can be added before, during, or after the addition of the binding agent to the particulate material. The amount of water added is the amount required to bring the moisture content of the particulate material (with or without binding agent) to the optimum level for the particular material being agglomerated. If the binding agent is added as a liquid solution or aqueous emulsion, then it may provide some or all of the water that is required to bring the moisture content of the particulate material to the optimum level for agglomeration. In preferred embodiments, the particulate material already has the desired final moisture content of from about 5% to 15% (more preferably from about 6% to 13%) prior to addition of the binding agent. Moisture content is equal to the moisture of the particulate material as measured by heating up to 105° C. If the particulate material does not contain the desired final moisture content before the binding agent is added, then water can be added to increase the moisture content.

Addition of the components comprising the binding agent described herein can be performed in any manner commonly applied or known to those skilled in the art. For example, the constituents of the binding agent may be mixed with the particulate matter in a dry or liquid form, or as an emulsion or dispersion, as the case may be. Furthermore, as those skilled in the art will also appreciate, the components of the binding agent can be simultaneously, successively, or alternatively added to the particulate material before or during the agglomerating process. In certain embodiments, for example, the second polymer of the binding agent can be blended just prior to, or substantially simultaneously with, mixing the binding agent with the particulate material to form the agglomerate feed.

In any or all embodiments related to processes of agglomerating, the process can further include drying and/or firing the shaped, wet agglomerated products at a suitable temperature and for a suitable time to produce a dried or sintered agglomerated product. Drying the wet agglomerated product and/or firing the resultant product can be carried out by any suitable means known to those skilled in the art, and can be performed as one continuous or two separate steps.

As those skilled in the art will also appreciate, if the agglomerated product is fired, it must first be dry, since agglomerated product will degrade or spall if fired without first drying them. It is therefore preferred that the agglomerated product be heated slowly (to prevent degradation and/or spalling). Generally suitable temperatures for drying the agglomerated product are from 100° C. to 400° C. Although the temperature for drying and/or firing the agglomerated product will largely depend on what type of particulate material is contained in the agglomerated product, such temperatures can be readily determined by those skilled in the art using no more than routine experimentation. Generally, a higher spalling temperature is a desirable quality. The tendency for spalling can be defined by determining the minimum temperature at which spalling occurs, or by observing the percentage of fines formed during a particular firing cycle. Advantageously, the binding agents used to form the agglomerated products described herein provide higher spalling temperatures than those obtained by the use of bentonite and other conventional binders.

In certain embodiments, where the particulate material of the agglomerated product contains minerals, the agglomerated product is heated slowly to a temperature of about 815° C. (about 1500° F.), and preferably to about 1320° C. (about 2400° F.), and then fired at that same temperature or greater (e.g., up to 1400° C.). In other embodiments, such as where the agglomerated product does not contain minerals (or at least not metallic minerals), the agglomerated products are dried at low temperatures (e.g., about 100° C. to 300° C.), preferably by heating, or alternatively, under ambient conditions (e.g, about 5° C. to 50° C.), and then fired at a temperature of at least about 815° C. to 1320° C.

Firing can be performed in a kiln (at least a portion of which has an inlet temperature in the range of 200° C. to 815° C.) or other suitable firing apparatus (e.g., blast furnace) for a sufficient period of time to bond the small particles into pellets or other shape, with enough strength to enable transportation and/or further handling. Again, as those skilled in the art will appreciate, the time sufficient to bond such particulate material to form the shaped agglomerated product will depend on a variety of factors such as type of particulate material agglomerated, size of agglomerated product, and/or type of binding agent used. Generally, drying and/or firing of the agglomerated product can be sufficiently performed in about 15 minutes to 3 hours.

### Various Embodiments

While certain embodiments may have been described herein in singular fashion, those skilled in the art will recognize that any of the embodiments described herein can be combined in the collective. The invention includes at least the following embodiments:
Embodiment 1. An agglomerated product comprising

i) a particulate material; and

ii) a binding agent comprising a polymer having a weight average molecular weight of 500 g/mol to 50,000 g/mol formed from water soluble ethylenically unsaturated monomers, or monomer blends, selected from the group consisting of:

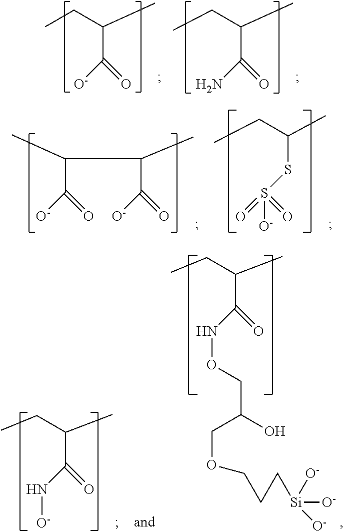

wherein each of the oxygen anions is independently hydrolyzed (—OH), methylated (—OCH3), or is a sodium (—ONa) or potassium (—OK) salt.
Embodiment 2. An agglomerated product according to embodiment 1, wherein said polymer comprises from 0 mol % to 100 mol % of acrylic acid and/or from 100 mol % to 0 mol % of acrylamide, provided that the amount of acrylic acid and acrylamide cannot both be 0 mol % or 100 mol %, and wherein said polymer has a weight average molecular weight of 2,000 g/mol to 15,000 g/mol.
Embodiment 3. An agglomerated product according to embodiment 2, wherein said polymer is a copolymer having from 30-50 mol % of acrylic acid and 70-50 mol % of acrylamide and has a weight average molecular weight of 2,000 g/mol to 12,000 g/mol.
Embodiment 4. An agglomerated product according to embodiment 1 or embodiment 2, wherein said polymer comprises from 90 mol % to 100 mol % of acrylic acid.
Embodiment 5. An agglomerated product according to embodiment 1, wherein said polymer comprises from 0 mol % to 100 mol % of sodium allyl sulfonate and/or from 100 mol % to 0 mol % of maleic acid, provided that the amount of sodium allyl sulfonate and maleic acid cannot both be 0 mol % or 100 mol %, and wherein said polymer has a weight average molecular weight of 500 g/mol to 5,000 g/mol.
Embodiment 6. An agglomerated product according to embodiment 5, wherein said polymer is a copolymer of 30-50 g/mol of sodium allyl sulfonate and 70-50 g/mol of maleic acid and has a weight average molecular weight of 1,000 to 3,000 g/mol.
Embodiment 7. An agglomerated product according to any one of embodiments 1 to 4, wherein said polymer is hydroxamated and/or silanated.
Embodiment 8. An agglomerated product according to embodiment 7, wherein said polymer has a weight average molecular weight of 5,000 g/mol to 10,000 g/mol.
Embodiment 9. An agglomerated product according to embodiment 7 or embodiment 8, wherein the polymer is silanated.
Embodiment 10. An agglomerated product according to any one of embodiments 1 to 9, wherein the polymer is in an aqueous or emulsion form, and is preferably an emulsion when hydroxamated and/or silanated.
Embodiment 11. An agglomerated product according to any one of embodiments 1 to 10, wherein the binding agent further comprises a second polymer in the form of an emulsion and having a weight average molecular weight of at least 500,000 g/mol formed from water soluble ethylenically unsaturated monomers, or monomer blends, selected from the group consisting of:

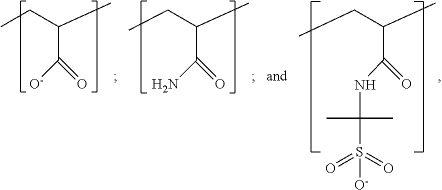

wherein each of the oxygen anions is independently hydrolyzed (—OH), methylated (—OCH3), or is a sodium (—ONa) or potassium (—OK) salt.
Embodiment 12. An agglomerated product according to embodiment 11, wherein said second polymer has a weight average molecular weight of at least 1,000,000 g/mol and comprises from 0 mol % to 100 mol % of acrylic acid and/or from 100 mol % to 0 mol % of acrylamide, provided that the amount of acrylic acid and acrylamide cannot both be 0 mol % or 100 mol %.
Embodiment 13. An agglomerated product according to embodiment 11 or embodiment 12, wherein said second polymer is a copolymer comprising from 30-50 mol % of acrylic acid and 70-50 mol % of acrylamide, based on 100 mol %.
Embodiment 14. An agglomerated product according to any of embodiments 11 to 13, wherein said second polymer is a copolymer of 50 mol % of acrylic acid and 50 mol % of acrylamide.
Embodiment 15. An agglomerated product according to any one of embodiments 1 to 3 and 11 to 14, wherein the binding agent comprises a first polymer in the form of an aqueous copolymer having 30 mol % acrylic acid and 70 mol % acrylamide and a weight average molecular weight from 2,000 g/mol to 12,000 g/mol, and a second polymer in the form of an emulsion copolymer having 50 mol % of acrylic acid and 50 mol % of acrylamide and a weight average molecular weight of at least 1,000,000 g/mol.
Embodiment 16. An agglomerated product according to any one of embodiments 11 to 13, wherein said second polymer further comprises from 5 mol % to 20 mol % of 2-acrylamido-2-methyl-1-propane sulfonic acid.
Embodiment 17. An agglomerated product according to any one of embodiments 11 to 16, wherein said second polymer is hydroxamated and/or silanated.
Embodiment 18. An agglomerated product according to any one of embodiments 11 to 17, wherein the second polymer is present in an amount from 30 mol % to 80 mol % in relation to the total polymer content of the binding agent.
Embodiment 19. An agglomerated product according to any one of embodiments 11 to 18, wherein the emulsion polymer has a weight average molecular weight from 1,000,000 g/mol to 50,000,000 g/mol.
Embodiment 20. An agglomerated product according to embodiment 19, wherein the emulsion polymer has a weight average molecular weight from 1,000,000 g/mol to 25,000,000 g/mol, more preferably from 1,000,000 g/mol to 10,000,000 g/mol.
Embodiment 21. An agglomerated product according to any one of embodiments 1 to 20, wherein the binding agent further comprises an additive selected from the group consisting of carboxy methyl cellulose; starch; urea; sodium acetate; sodium citrate; sodium chloride; sodium oxalate; sodium tartrate; sodium benzoate; sodium stearate; sodium bicarbonate; sodium carbonate; sodium silicate; and the corresponding ammonium, potassium, calcium, or magnesium salts of the preceding salts; calcium oxide; calcium hydroxide; calcium carbonate; magnesium oxide; magnesium hydroxide; clay minerals; wollastonite; guar and mixtures thereof.
Embodiment 22. An agglomerated product according to embodiment 21, wherein the clay mineral is a phyllosilicate mineral selected from the group consisting of serpentine minerals; kaolinite; talc; pyrophyllite; mica; illite; vermiculite; bentonite; and mixtures thereof.
Embodiment 23. An agglomerated product according to any one of embodiments 1 to 22, wherein said binding agent is present in an amount from 0.001 wt. % to 5 wt. % of the total weight of the agglomerated product.
Embodiment 24. An agglomerated product according to embodiment 23, wherein said binding agent is present in an amount from 0.001 wt. % to 1.5 wt. % of the total weight of the agglomerated product.
Embodiment 25. An agglomerated product according to any one of embodiments 1 to 24, wherein said particulate material is one or more member selected from the group consisting of minerals; fertilizers; and wood pulp.
Embodiment 26. An agglomerated product according to embodiment 25, wherein the particulate material is a mineral in the form of a concentrate, a tailing, fines, and/or ore.
Embodiment 27. An agglomerated product according to embodiment 25 or embodiment 26, wherein said mineral is metallic and selected from the group consisting of iron ore; taconite; magnetite; hematite; limonite; goethite; siderite; franklinite; pyrite; chalcopyrite; chromite; ilmenite; chrome ore; gold ore; silver ore; copper ore; nickel ore; zinc ore; lead ore; uranium ore; barium ore; niobium; casiterite; rutile; and mixtures thereof.
Embodiment 28. An agglomerated product according to embodiment 27, wherein said mineral is iron ore (haematite, magnetite, and/or taconite).
Embodiment 29. An agglomerated product according to embodiment 25 or embodiment 26, wherein said mineral is non-metallic and selected from the group consisting of phosphate rock; talc; dolomite; limestone; potassium sulfate; ammonium phosphate; potassium chloride; double sulfate of potassium and magnesium; magnesium oxide; calcium phosphate; carbon black; coal; calcite, quartz; and mixtures thereof.
Embodiment 30. An agglomerated product according to any one of embodiments 1 to 29, wherein said particulate material is present in an amount of at least 95 wt. % of the total weight of the agglomerated product.
Embodiment 31. An agglomerated product according to any one of embodiments 1 to 30, wherein the product is in the form of a pellet or briquette.
Embodiment 32. A process for agglomerating a particulate material, the process comprising:

a) forming an intimate mixture of the particulate material and an effective amount of a binding agent as defined in any one of embodiments 1 to 24 in the presence of moisture to obtain an agglomerate feed; and

b) shaping the feed into a plurality of wet agglomerated products by any suitable means, thereby agglomerating a particulate material.
Embodiment 33. A process according to embodiment 32, wherein the process further comprises:

c) drying and/or firing the shaped, wet agglomerated products at a temperature and for a time suitable to produce dried or sintered agglomerated products.
Embodiment 34. A process according to embodiment 32 or embodiment 33, wherein said particulate material is one or more member selected from the group consisting of minerals; fertilizers; and wood pulp.
Embodiment 35. A process according to embodiment 34, wherein the particulate material is a mineral in the form of a concentrate, a tailing, fines, and/or ore.
Embodiment 36. A process according to embodiment 35, wherein said mineral is iron ore.
Embodiment 37. A process according to any one of embodiments 32 to 36, wherein the binding agent comprises bentonite, an aqueous copolymer having 30 mol % acrylic acid and 70 mol % acrylamide and a weight average molecular weight from 2,000 g/mol to 12,000 g/mol, and an emulsion copolymer having 50 mol % of acrylic acid and 50 mol % of acrylamide and a weight average molecular weight of at least 1,000,000 g/mol.
Embodiment 38. A process according to embodiment 37, wherein the aqueous copolymer and the emulsion polymer are blended just prior to, or substantially simultaneously with, mixing the binding agent with the particulate material to form the feed.
Embodiment 39. A process according to any one of embodiments 32 to 38, wherein the agglomerated products are in the form of pellets or briquettes.
Embodiment 40. Use of a binding agent as defined in any one of embodiments 1 to 24 in producing an agglomerated product according to any one of embodiments 1 to 31.

### EXAMPLES

The following examples are provided to assist one skilled in the art to further understand certain embodiments of the present invention. These examples are intended for illustration purposes and are not to be construed as limiting the scope of the various embodiments of the present invention.

### Example 1

### Lab-Scale Production of Iron Ore Green Balls and Pellets

The following is a description of iron ore green ball and pellet production in a laboratory setting. This process is accepted by those skilled in the art to replicate plant-scale results and can also be used for agglomerating particulate materials of other substances with no more than routine experimentation or modifications.

Concentrated iron ore obtained from an iron ore processing plant is weighed to 3 kg on a dry basis. Water may be added to the concentrated iron ore to bring the overall moisture level up to 9-12%, depending on the pelletization requirements of the ore. The water added may be distilled water, tap water, deionized water, or process water from a processing facility. The concentrate ore is mixed by hand to incorporate the added water. A binding agent according to the invention as described herein is added to the iron ore concentrate and further mixed by hand. A clay material can be included in the binding agent according to the invention or can be separately added to the iron ore concentrate and mixed into the iron ore concentrate by hand. While the clay material can be a single material or any number of different clay-like materials, bentonite is the typical material and is added as a dry powder. The typical dosage of the clay material is from 0 to 20 kg/mt. Hand mixing involves turning the ore over upon itself at least 10 times in a stainless steel mixing bowl using gloved hands. The mixture of concentrated iron ore, binding reagent, and bentonite (referred to as “pelletization feed”) is then thoroughly mixed using a mixing machine of any suitable type known to those skilled in the art. The pelletization feed is allowed to sit in a covered bowl for a set period of time, typically between 0 and 15 minutes, prior to mixing in a mixer that consists of rotating discs that act to break up clumps.

To prepare the wet agglomerates of iron ore (known to those skilled in the art as “green balls” or “wet green balls”), a small amount of the pelletization feed is added to a rotating (−54 rpm) laboratory balling drum (e.g., a retired Cessna personal airplane tire) along with spray water to generate small seed pellets. The seed pellets are removed from the drum and screened. For this procedure, 230 g of seed pellets sized from 1.6 mm to 6.4 mm are created. The screened seed pellets are added back to the rotating drum. Additional pelletization feed and spray water are added incrementally until all of the pelletization feed has been added. The laboratory scale agglomeration process, from the time the seed pellets are added to the drum to the time the green balls are removed, is performed over a 4 minute period.

Upon completion of laboratory agglomeration, the green balls are screened at 9.5 mm, 11.1 mm, and 12.7 mm. 10 green balls are dropped from a height of 45.7 cm onto a steel plate. The average number of drops each green ball sustains prior to cracking is referred to as the “wet drop number.” 10 green balls are then dried at 100 degrees Celsius for at least 2 hours and the compression strength required to break them is recorded as the “dry strength.” The moisture content of the green balls is also calculated at this time by comparing the mass of the green balls to the mass of the dry green balls. Weight measurements can be taken using equipment known to those skilled in the art.

The wet drop number is only significant in that it must exceed a specified value in order for a green ball to survive the conveyor process that leads to the sintering furnace at the plant. The test is designed to simulate drops from a conveyor belt onto another conveyor belt. The values obtained for dry strength and moisture content are significant. The dry strength is an indication of whether a green ball will survive the sintering process. The moisture content is an indication of how much water was retained within the pellet; where, too little water retained results in excessive amounts of undersize green balls at a production plant. Bentonite tends to absorb water readily and is used at the plant to control green ball growth kinetics.

Green balls between 9.5 mm and 12.7 mm are also sintered to determine the sintered strength and the propensity for abrasion (known to those skilled in the art as “abrasion index” or “tumble fines”, respectively) of the final pellet products. The laboratory sintering process includes preheating a natural gas-fired furnace to 260 degrees Celsius, adding green balls into a 6 inch deep crucible, inserting the crucible into the furnace, heating the furnace through a firing cycle that extends up to 1,316 degrees Celsius over a 15 minute period, and cooling the pellets to room temperature. The firing cycle is designed to mimic the heating zones at an industrial scale sintering furnace.

The sintered pellets are then tested for sintered strength and tumble fines. The sintered strength is measured using a compression testing apparatus capable of fracturing a sintered pellet and measuring the peak force required to cause a pellet to fracture. 100 sintered pellets are crushed and the peak force required to break each pellet is averaged to generate a value referred to as the sintered strength. The tumble fines are measured by allowing sintered pellets to tumble in a drum of fixed dimensions and for a fixed number of revolutions following which the amount of abraded material is weighed as a percentage of overall pellet mass. In the following examples, 500 grams of sintered pellets are allowed to tumble for 200 revolutions in a 1.2 m diameter 0.3 m wide steel drum with horizontal lifting baffles. The tumbled pellets are then screened to determine the mass of abraded material passing through a 6.4 mm screen. The percentage of material passing through the screen is referred to as “tumble fines.”

The sintered strength typically must exceed 180 kgf (kilograms force) to allow the pellet to survive the stacking and shipping process; however, this minimum can vary. The specification for the maximum tumble fines varies from process to process, but is typically in the vicinity of 4-5%.

### Example 2

### Lab-Scale Production of Iron Ore Green Balls and Pellets Using Bentonite as the Binding Agent

Laboratory scale pelletization tests are performed as above for Example 1 using a magnetite concentrate (Fe₃O₄) from an iron mine, and a standard sodium bentonite used industrially for pelletization applications as the binding agent. As a baseline comparison, two tests were performed using 8.0 and 4.0 kg of bentonite per metric ton (“mt”) of ore concentrate, and the resulting wet drop number, dry strength, and moisture content are shown in Table 1.

TABLE 1
Bentonite as the sole binding agent in green ball and pellet formation

| | | Binder | Wet | Dry | Green Ball |
|---|---|---|---|---|---|
| | Binder | Dose | Drop | Strength, | Moisture, |
| Example No. | Agent | kg/mt | Number | kgf | % |
| 2.1 - Comparative | Bentonite | 8.0 | 7.2 | 3.2 | 9.5 |
| 2.2 - comparative | Bentonite | 4.0 | 4.2 | 1.5 | 9.1 |

As shown in Table 1, as bentonite content is reduced, the resulting moisture content is reduced. This negatively impacts the ability for the pellet plant to produce adequately sized green balls. Accordingly, any binder additions must counteract the loss in moisture retention seen with bentonite reduction.

The limiting factor on bentonite dose reduction, in many cases, is moisture absorption. In this case, the moisture must be maintained at 9.5%. Reducing bentonite from 8.0 to 4.0 kg/mt reduces the moisture absorption capability of the overall binding agent. It is currently well known to those skilled in the art that the addition of a high molecular weight (“HMW”) dry polyacrylamide-based polymer (i.e., “HMW DPAM”) is capable of supplementing bentonite as the binding agent to increase moisture absorption. However, this type of binding agent (HMW DPAM+bentonite), while providing the benefit of increasing moisture absorption, fails to provide the dry strength and wet drop numbers required to create a green ball that will survive a furnace.

As further exemplified below, the agglomerated pellets using binding agents according to those currently described and claimed by the present invention overcome this issue, by increasing moisture absorption and/or increasing the performance of the remaining bentonite.

### Example 3

### Lab-Scale Production of Iron Ore Green Balls and Pellets Using Bentonite and a Low Molecular Weight Aqueous Polyacrylamide as the Binding Agent (Partial Replacement of Bentonite)

Laboratory scale pelletization tests are performed as above for Example 1 using a magnetite concentrate (Fe₃O₄) from an iron mine, and sodium bentonite partially replaced/blended with a low molecular weight aqueous polyacrylamide as the binding agent.

The low molecular weight (“LMW”) polyacrylamide polymer (Binder 2-A) contains sufficient amount of charged monomers to cause a dispersion of the bentonite platelets throughout the balling feed. This increases the effectiveness of the remaining bentonite to provide the wet drop and dry strength required for the process and is, therefore, viable as a binding agent. Examples of the use of Binder 2-A with bentonite and the resulting wet drop number, dry strength, and green ball moisture are shown in Table 2.

TABLE 2
Examples of a LMW polyacrylamide polymer as binder used to reduce
bentonite consumption in green ball and pellet formation.

| | | Binder | | Binder | | Dry | |
|---|---|---|---|---|---|---|---|
| Example | | 1 Dose | | 2 Dose, | Wet Drop | Strength, | Green Ball |
| No. | Binder 1 | kg/mt | Binder 2 | kg/mt | Number | kgf | Moisture, % |
| 3.1 | Bentonite | 4.0 | A* | 0.89 | 5.8 | 3.6 | 9.4 |
| 3.2 | Bentonite | 4.0 | A | 0.67 | 6.3 | 2.8 | 9.2 |
| 3.3 | Bentonite | 4.0 | A | 0.45 | 4.7 | 2.4 | 9.3 |
| 3.4 | Bentonite | 4.0 | A | 0.22 | 4.5 | 2.0 | 9.3 |
| 3.5 | Bentonite | 2.0 | A | 0.89 | 6.1 | 2.4 | 9.2 |
| 3.6 | Bentonite | 2.0 | A | 0.45 | 4.5 | 1.5 | 9.3 |
| 3.7 | Bentonite | 2.0 | A | 0.22 | 4.6 | 1.3 | 9.2 |

*Binder 2 - A = low molecular weight (~10K g/mol) polyacrylic acid polyacrylamide copolymer having 30 mol % acrylic acid monomers and 70 mol % acrylamide monomers in polymer, prepared as a 50% aqueous polymeric reagent.

### Example 4

### Lab-Scale Production of Iron Ore Green Balls and Pellets Using Bentonite and a Low Molecular Weight Aqueous Sodium Allyl Sulfonate Maleic Acid Copolymer (SASMAC) as the Binding Agent (Partial Replacement of Bentonite)

Laboratory scale pelletization tests are performed as above for Example 1 using a magnetite concentrate (Fe₃O₄) from an iron mine, and sodium bentonite partially replaced/blended with a low molecular weight aqueous SASMAC as the binding agent.

The low molecular weight SASMAC polymer (Binder 2-B) contains sufficient amount of charged monomers to cause a dispersion of the bentonite platelets throughout the balling feed. This increases the effectiveness of the remaining bentonite to provide the wet drop and dry strength required for the process and is, therefore, viable as a binding agent. Examples of the use of Binder 2-B with bentonite and the resulting wet drop number, dry strength, and green ball moisture are shown in Table 3.

TABLE 3
Examples of a LMW sodium allyl sulfonate maleic acid copolymer as binder
used to reduce bentonite consumption in green ball and pellet formation.

| | | Binder | | Binder | | Dry | |
|---|---|---|---|---|---|---|---|
| Example | | 1 Dose | | 2 Dose, | Wet Drop | Strength, | Green Ball |
| No. | Binder 1 | kg/mt | Binder 2 | kg/mt | Number | kgf | Moisture, % |
| 4.1 | Bentonite | 4.0 | B* | 0.33 | 4.7 | 3.0 | 8.8 |
| 4.2 | Bentonite | 4.0 | B | 0.22 | 4.5 | 2.6 | 9.3 |
| 4.3 | Bentonite | 4.0 | B | 0.11 | 3.8 | 1.9 | 9.5 |
| 4.4 | Bentonite | 2.0 | B | 0.33 | 3.4 | 1.9 | 9.1 |
| 4.5 | Bentonite | 2.0 | B | 0.22 | 4.3 | 1.6 | 8.8 |
| 4.6 | Bentonite | 2.0 | B | 0.11 | 3.4 | 1.5 | 9.1 |

*Binder 2 - B = low molecular weight (~2K g/mol) sodium allyl sulfonate maleic acid copolymer having 50 mol % sodium allyl sulfonate monomers and 50 mol % maleic acid monomers in polymer, prepared as a 39.5% aqueous polymeric reagent.

### Example 5

### Lab-Scale Production of Iron Ore Green Balls and Pellets Using Bentonite blended with a Low Molecular Weight Aqueous Polyacrylamide and a High Molecular Weight Emulsion Polyacrylamide as the Binding Agent (Partial Replacement of Bentonite)

While the low molecular weight polyacrylamide or SASMAC polymer in aqueous form (Binders 2-A, B) blended with bentonite is effective as a binding agent/package, it alone does not increase the moisture absorption of the binder package adequately enough for a commercial plant to operate a balling drum or disk.

The addition of a moisture-absorbing component to the binder packages shown in Table 2 or 3 is required to create a binding agent that is capable of being effectively applied at a commercial iron ore pelletization plant. The mixture of a polymer or co-dosing a polymer similar to Binders 2-A, B with another polymer (i.e., a high molecular weight (“HMW”) polymer) is a new concept that has heretofore never been thought of or tried.

Pre-blending a low molecular weight aqueous polymer, such as Binders 2-A, B with a high molecular weight polymer emulsion, inverse emulsion, or microemulsion, such as Binders 3-D, E, F and G, creates a destabilized emulsion; however, within certain bounds, does not allow the emulsion to break before being applied to the balling feed. Prior to the present invention, it was assumed that the addition of any of these high molecular weight polymer emulsions to an aqueous environment, such as Binders 2-A, B would fully destabilize the emulsion resulting in an un-manageable polymer solution; however, this was not the case.

The partially destabilized emulsion blended with a reagent such as Binders 2-A, B could then be applied to the balling feed where the particulates in the balling feed fully destabilized the emulsion allowing for substantial moisture absorption at low dosages in the blend. This was a surprising and unexpected result. It was also noticed that this blend, though viscous, was easily intimately mixed into the balling feed. This could not be done with a stable emulsion alone. Examples of the use of a blend of Binder 2-A with emulsion polymers is outlined in Table 4 below.

TABLE 4
Binding agent packages created using the components listed in Table 2 co-dosed
with a HMW emulsion or microemulsion polymer and bentonite, and the resulting wet
drop numbers, dry strengths, and green ball moistures.

| | | Binder 1 | | Binder 2 | | Binder 3 | Wet | Dry | Green |
|---|---|---|---|---|---|---|---|---|---|
| Example | | Dose | | Dose, | | Dose. | Drop | Strength, | Ball |
| No. | Binder 1 | kg/mt | Binder 2 | kg/mt | Binder 3 | kg/mt | Number | kgf | Moisture, % |
| 5.1 | Bentonite | 4.0 | A | 0.45 | D* | 0.045 | 4.7 | 1.9 | 9.3 |
| 5.2 | Bentonite | 4.0 | A | 0.45 | D* | 0.067 | 5.2 | 1.8 | 9.3 |
| 5.3 | Bentonite | 4.0 | A | 0.45 | E* | 0.022 | 5.0 | 2.3 | 9.5 |
| 5.4 | Bentonite | 4.0 | A | 0.45 | E* | 0.045 | 5.1 | 2.2 | 9.4 |
| 5.5 | Bentonite | 4.0 | A | 0.45 | E* | 0.067 | 4.7 | 2.2 | 9.5 |
| 5.6 | Bentonite | 4.0 | A | 0.45 | E* | 0.134 | 5.6 | 2.0 | 10.1 |
| 5.7 | Bentonite | 4.0 | A | 0.45 | E* | 0.268 | 6.5 | 1.6 | 10.0 |
| 5.8 | Bentonite | 4.0 | A | 0.223 | E* | 0.067 | 6.4 | 1.5 | 9.6 |
| 5.9 | Bentonite | 4.0 | A | 0.223 | E* | 0.134 | 4.9 | 1.8 | 9.8 |
| 5.10 | Bentonite | 4.0 | A | 0.223 | E* | 0.268 | 5.3 | 1.6 | 10.0 |
| 5.11 | Bentonite | 4.0 | A | 0.00 | E | 0.134 | 4.4 | 1.5 | 9.5 |
| 5.12 | Bentonite | 4.0 | A | 0.00 | E | 0.268 | 3.7 | 1.5 | 9.6 |
| 5.13 | Bentonite | 4.0 | A | 0.45 | F* | 0.045 | 5.3 | 2.2 | 9.4 |
| 5.14 | Bentonite | 4.0 | A | 0.45 | G* | 0.067 | 5.6 | 2.1 | 9.7 |
| 5.15 | Bentonite | 4.0 | A | 0.45 | G* | 0.134 | 5.4 | 2.1 | 10.8 |

*Binder prepared by blending the two liquid components on a magnetic stir plate at 200 rpm prior to addition to balling feed as a single reagent.
Binder 3 - D = High molecular weight (>1,000K g/mol) polyacrylic acid-polyacrylamide copolymer having 3 mole percent acrylic acid monomers and 97 mole percent acrylamide monomers in the form of an emulsion polymer;
inder 3 - E = High molecular weight (>1,000K g/mol) polyacrylic acid-polyacrylamide copolymer having 30 mole percent acrylic acid monomers, and 70 mole percent acrylamide monomers in the form of an emulsion polymer;
Binder 3 - F = High molecular weight (>1,000K g/mol) cross-linked polyacrylic acid-polyacrylamide-2-acrylamido-2-methylpropane sulfonic acid terpolymer having 40 mole percent acrylic acid monomers, 55 mole percent acrylamide monomers, and 5 mole percent 2-acrylamido-2-methylpropane sulfonic acid in the form of a microemulsion polymer;
Binder 3 - G = High molecular weight (>1,000K g/mol) polyacrylic acid-polyacrylamide copolymer having 60 mole percent acrylic acid monomers, and 40 mole percent acrylamide copolymers in the form of a microemulsion polymer.

At the iron ore plant scale, the amount of moisture that is required to be absorbed is dependent upon a number of factors. However, the main contributing factor is the moisture content of the incoming balling feed. This varies depending upon the performance of the concentrate filters and the humidity in the air. At a plant scale, application of the liquid binder combinations (e.g., Binder 2-A blended with Binders 3-D, E, F and/or G) is limited by the viscosity tolerated by the application equipment.

The inventors have discovered that the best approach to accounting for variable moisture in the balling feed is to blend the liquid polymer binding agent on site just prior to, or substantially simultaneously with, applying the binding agent to the balling feed. While on site blending just prior to application can be accomplished according by any means known to those skilled in the art, the inventors have contemplated at least two ways for accomplishing this, which include:
1. Batch blending: Adding an aqueous reagent similar to Binder 2-A to a holding tank followed by a high molecular weight emulsion polymer similar to Binder 3-D, E, F or G. These reagents are then mixed thoroughly using a low-shear mixer prior to being pumped to a polymer distribution system such as a weir or manifold placed over the balling feed conveyor belt in such a way that the blended binding reagent is evenly distributed across the belt; and/or
2. Continuous blending: Using an in-line static mixer to blend the LMW aqueous polymer reagent with the HMW emulsion polymer reagent prior to feeding the polymer distribution system described in method 1 above. This method has the advantage of lag-less moisture control.

### Example 6

### Lab-Scale Production of Iron Ore Green Balls and Pellets Using Bentonite and a Low Molecular Weight Silanated and/or Hydroxamated Polyacrylamide as the Binding Agent (Partial Replacement of Bentonite)

Laboratory scale pelletization tests are performed as above for Example 1 using a magnetite concentrate (Fe₃O₄) from an iron mine, and sodium bentonite partially replaced/blended with a low molecular weight aqueous or emulsion silanated and/or hydroxamated polyacrylamide as the binding agent.

The low molecular weight polymers, such as Binders 2-H, I, J, and K, are surprisingly effective because it is believed that they contain a sufficient amount of charged monomers to cause a dispersion of the bentonite platelets throughout the balling feed. This increases the effectiveness of the remaining bentonite to provide the wet drop and dry strength required for the process and is, therefore, viable as a binding agent. The polymer also contains functional species that act to increase the desired pellet properties.

This was an unexpected result. Examples of the use of Binders 2-H, I, J, and K with bentonite and the resulting wet drop number, dry strength, and green ball moisture are shown in Table 5.

TABLE 5
Examples of LMW aqueous or emulsion polyacrylamide polymers that have
been silanated and/or hydroxamated as binder used to reduce bentonite consumption in
green ball and pellet formation.

| | | Binder | | Binder | | Dry | |
|---|---|---|---|---|---|---|---|
| Example | | 1 Dose | | 2 Dose, | Wet Drop | Strength, | Green Ball |
| No. | Binder 1 | kg/mt | Binder 2 | kg/mt | Number | kgf | Moisture, % |
| 6.1 | Bentonite | 4.0 | H* | 1.54 | 7.2 | 3.2 | 9.6 |
| 6.2 | Bentonite | 4.0 | H | 0.77 | 7.9 | 2.3 | 9.9 |
| 6.3 | Bentonite | 4.0 | H | 0.39 | 5.1 | 2.0 | 9.5 |
| 6.4 | Bentonite | 4.0 | I* | 1.13 | 6.2 | 3.3 | 9.3 |
| 6.5 | Bentonite | 4.0 | J* | 2.36 | 9.9 | 3.4 | 10.1 |
| 6.6 | Bentonite | 4.0 | K* | 0.55 | 5.1 | 2.4 | 9.4 |

*Binder 2 - H = Low molecular weight (~10k g/mol) hydroxamated polyacrylamide polymer prepared as a 14.7% active emulsion polymer;
Binder 2 - I = Low molecular weight (~10k g/mol) hydroxamated polyacrylamide polymer prepared as a 20.0% active aqueous polymer;
Binder 2 - J = Low molecular weight (~10k g/mol) silanated hydroxamated polyacrylamide polymer prepared as a 9.6% active emulsion polymer;
Binder 2 - K = Low molecular weight (~10k g/mol) silanated polyacrylic acid polyacrylamide copolymer prepared as a 41.0% active aqueous polymer;

Various patent and/or scientific literature references have been referred to throughout this application. The disclosures of these publications in their entireties are hereby relied on as if written herein to provide interpretation to the claim terms as necessary. However, if a term in the present application contradicts or conflicts with a term in the incorporated reference, the term from the present application takes precedence over the conflicting term from the reference. In view of the above description and the examples, one of ordinary skill in the art will be able to practice the disclosure as claimed without undue experimentation.

While typical embodiments have been set forth for the purpose of illustrating the fundamental novel features of the present invention, the foregoing descriptions should not be deemed to be a limitation on the scope of the invention presented herein. Accordingly, various modifications, adaptations, and alternatives can occur to one skilled in the art without departing from the spirit and scope of the invention described herein, and the scope of the invention should be defined by the appended claims.

What is claimed is:

1. An agglomerated product comprising
i) a particulate material; and
ii) a binding agent comprising a polymer having a weight average molecular weight of 500 g/mol to 50,000 g/mol formed from water soluble ethylenically unsaturated monomers, or monomer blends, selected from the group consisting of: 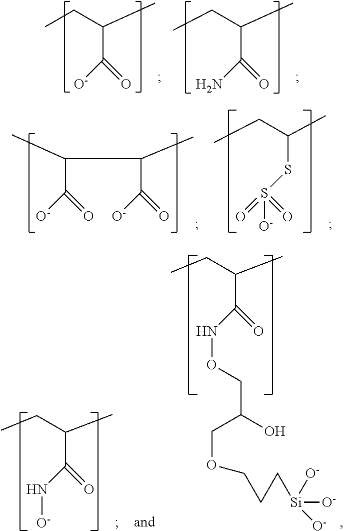
wherein each of the oxygen anions is independently hydrolyzed (—OH), methylated (—OCH3), or is a sodium (—ONa) or potassium (—OK) salt.

2. An agglomerated product according to claim 1, wherein said polymer comprises from 0 mol % to 100 mol % of acrylic acid and/or from 100 mol % to 0 mol % of acrylamide, provided that the amount of acrylic acid and acrylamide cannot both be 0 mol % or 100 mol %, and wherein said polymer has a weight average molecular weight of 2,000 g/mol to 15,000 g/mol.

3. An agglomerated product according to claim 2, wherein said polymer is a copolymer having from 30-50 mol % of acrylic acid and 70-50 mol % of acrylamide and has a weight average molecular weight of 2,000 g/mol to 12,000 g/mol.

4. An agglomerated product according to claim 1, wherein said polymer comprises from 90 mol % to 100 mol % of acrylic acid.

5. An agglomerated product according to claim 1, wherein said polymer is hydroxamated and/or silanated.

6. An agglomerated product according to claim 5, wherein said polymer has a weight average molecular weight of 5,000 g/mol to 10,000 g/mol.

7. An agglomerated product according to claim 5, wherein the polymer is silanated.

8. An agglomerated product according to claim 1, wherein the polymer is in an aqueous or emulsion form.

9. An agglomerated product according to claim 1, wherein the binding agent further comprises a second polymer in the form of an emulsion and having a weight average molecular weight of at least 500,000 g/mol formed from water soluble ethylenically unsaturated monomers, or monomer blends, selected from the group consisting of: 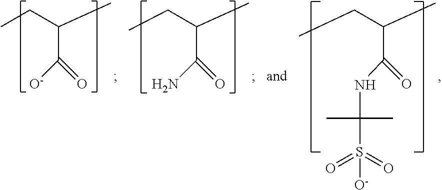
wherein each of the oxygen anions is independently hydrolyzed (—OH), methylated (—OCH3), or is a sodium (—ONa) or potassium (—OK) salt.

10. An agglomerated product according to claim 9, wherein said second polymer has a weight average molecular weight of at least 1,000,000 g/mol and comprises from 0 mol % to 100 mol % of acrylic acid and/or from 100 mol % to 0 mol % of acrylamide, provided that the amount of acrylic acid and acrylamide cannot both be 0 mol % or 100 mol %.

11. An agglomerated product according to claim 9, wherein said second polymer is a copolymer comprising from 30-50 mol % of acrylic acid and 70-50 mol % of acrylamide, based on 100 mol %.

12. An agglomerated product according to claim 9, wherein said second polymer is a copolymer of 50 mol % of acrylic acid and 50 mol % of acrylamide.

13. An agglomerated product according to claim 1, wherein the binding agent comprises a first polymer in the form of an aqueous copolymer having 30 mol % acrylic acid and 70 mol % acrylamide and a weight average molecular weight from 2,000 g/mol to 12,000 g/mol, and a second polymer in the form of an emulsion copolymer having 50 mol % of acrylic acid and 50 mol % of acrylamide and a weight average molecular weight of at least 1,000,000 g/mol.

14. An agglomerated product according to claim 9, wherein the second polymer is present in an amount from 30 mol % to 80 mol % in relation to the total polymer content of the binding agent.

15. An agglomerated product according to claim 9, wherein the emulsion polymer has a weight average molecular weight from 1,000,000 g/mol to 50,000,000 g/mol.

16. An agglomerated product according to claim 15, wherein the emulsion polymer has a weight average molecular weight from 1,000,000 g/mol to 25,000,000 g/mol, more preferably from 1,000,000 g/mol to 10,000,000 g/mol.

17. An agglomerated product according to claim 1, wherein the binding agent further comprises a clay mineral selected from the group consisting of serpentine minerals; kaolinite;
talc; pyrophyllite; mica; illite; vermiculite; bentonite; and mixtures thereof.

18. An agglomerated product according to claim 1, wherein said binding agent is present in an amount from 0.001 wt. % to 5 wt. % of the total weight of the agglomerated product.

19. An agglomerated product according to claim 18, wherein said binding agent is present in an amount from 0.001 wt. % to 1.5 wt. % of the total weight of the agglomerated product.

20. An agglomerated product according to claim 1, wherein said particulate material is one or more member selected from the group consisting of minerals; fertilizers; and wood pulp.

21. An agglomerated product according to claim 20, wherein the particulate material is a mineral in the form of a concentrate, a tailing, fines, and/or ore.

22. An agglomerated product according to claim 20, wherein said mineral is metallic and selected from the group consisting of iron ore; taconite; magnetite; hematite; limonite; goethite; siderite; franklinite; pyrite; chalcopyrite; chromite; ilmenite; chrome ore; gold ore; silver ore; copper ore; nickel ore; zinc ore; lead ore; uranium ore; barium ore; niobium; casiterite; rutile; and mixtures thereof.

23. An agglomerated product according to claim 22, wherein said mineral is iron ore (hematite, magnetite, and/or taconite).

24. An agglomerated product according to claim 1, wherein said particulate material is present in an amount of at least 95 wt. % of the total weight of the agglomerated product.

25. An agglomerated product according to claim 1, wherein the product is in the form of a pellet or briquette.

26. A process for agglomerating a particulate material, the process comprising:
a) forming an intimate mixture of the particulate material and an effective amount of a binding agent as defined in claim 1 in the presence of moisture to obtain an agglomerate feed; and
b) shaping the feed into a plurality of wet agglomerated products by any suitable means, thereby agglomerating a particulate material.

27. A process according to claim 26, wherein the process further comprises:
c) drying and/or firing the shaped, wet agglomerated products at a temperature and for a time suitable to produce dried or sintered agglomerated products.

28. A process according to claim 26, wherein said particulate material is one or more member selected from the group consisting of minerals; fertilizers; and wood pulp.

29. A process according to claim 28, wherein the particulate material is a mineral in the form of a concentrate, a tailing, fines, and/or ore.

30. A process according to claim 29, wherein said mineral is iron ore.

31. A process according to claim 26, wherein the binding agent comprises bentonite, an aqueous copolymer having 30 mol % acrylic acid and 70 mol % acrylamide and a weight average molecular weight from 2,000 g/mol to 12,000 g/mol, and an emulsion copolymer having 50 mol % of acrylic acid and 50 mol % of acrylamide and a weight average molecular weight of at least 1,000,000 g/mol.

32. A process according to claim 31, wherein the aqueous copolymer and the emulsion polymer are blended just prior to, or substantially simultaneously with, mixing the binding agent with the particulate material to form the feed.

33. A process according to claim 26, wherein the agglomerated products are in the form of pellets or briquettes.
